(19) United States
(12) Patent Application Publication
(10) Pub. No.: US 2026/0178410 A1
(43) Pub. Date: Jun. 25, 2026

(54) Dynamic Management Of Node Headroom To Accommodate Startup Spikes

(71) Applicant: NetApp, Inc., San Jose, CA (US)

(72) Inventors: Alexander Glikson, Givatayim (IL); Oren Gurfinkel, Rishon Le Zion (IL); Roi Kramer, Ramat Gan (IL); Baruch Mordechai Susman, Jerusalem (IL); Tal Shmuel Shafir, Yavne (IL); Oded Hoffman, Tel Aviv (IL)

(21) Appl. No.: 19/036,949

(22) Filed: Jan. 24, 2025

Related U.S. Application Data
(60) Provisional application No. 63/737,350, filed on Dec. 20, 2024.

(51) Int. Cl. G06F 9/50; G06F 9/445

(52) U.S. Cl. CPC G06F 9/505; G06F 9/445

(57) ABSTRACT

The disclosure describes a node management service that dynamically adjusts node capacity in orchestration platforms. The service leverages an extended resource definition to reflect the increased resource needs during the startup phase of workloads, then reallocates these resources once the workload transitions to steady-state operation. Workloads are provisioned with both a native resource request and an extended resource request to cover initialization spikes. Once initialization completes, the node management service updates the node's metadata to increase available extended resource capacity, thereby freeing up headroom for future deployments.

### CROSS-REFERENCE TO RELATED APPLICATIONS

This application claims priority to U.S. Provisional Patent Application No. 63/737,350 titled “DYNAMIC MANAGEMENT OF NODE HEADROOM TO ACCOMMODATE STARTUP SPIKES,” filed Dec. 20, 2024, the contents of which is incorporated by reference in its entirety for all purposes.

### BACKGROUND

Containerized applications running in a compute cluster (e.g., a Kubernetes cluster) frequently exhibit increased resource demands for CPU and memory during their startup phase, before settling into a lower steady-state usage. For example, applications may experience significant CPU overhead on startup due to operations like class loading, caching large amounts of data, and initializing background services. These temporary resource demands, if not adequately accounted for, can cause the startup of new pods to fail or become severely throttled in highly utilized clusters.

Balancing this initial surge against the generally lower steady-state resource usage presents challenges in workload orchestration. If CPU or memory request values (identifying the minimum reservation for containerized applications or pods) are set high enough to handle startup peaks, those resources may sit underutilized the rest of the time, driving up costs and wasting capacity of nodes in the cluster. Conversely, setting request values to align with steady-state operations may lead to resource contention when multiple applications attempt to start at the same time, causing throttling and even timeouts or crashes.

### SUMMARY

The disclosure describes a node management service that leverages extended resource configurations to flexibly accommodate both startup and steady-state resource demands for workloads in a compute cluster. In some implementations, the node management service determines a first request value for a pod (corresponding to a steady state usage) and a second request value (corresponding to initialization usage). The node management service provides these request values to the cluster's control plane for scheduling. Once the pod's initialization on the node is complete, the node management service updates the node's capacity metadata to reflect resource availability.

Adjusting the extended resource capacity can involve setting the node's capacity value to a value that may exceed the node's actual capacity. This effectively frees up the “headroom” initially reserved for the pod's startup phase, allowing the scheduler to consider this headroom when placing future pods. Meanwhile, the native CPU request (the first request value) of the pod can be configured at a lower value to only consume the CPU needed for the pod's steady-state usage. In this manner, the node management service prevents unnecessary overprovisioning while providing that initialization phases of newly deployed pods are provided necessary resources.

### BRIEF DESCRIPTION OF THE DRAWINGS

FIG. 1 illustrates a computing environment in an implementation.

FIG. 2 illustrates a process for managing resource requests in an implementation.

FIG. 3 illustrates an operational sequence in an implementation.

FIGS. 4A and 4B illustrate a workflow for pod deployment in an implementation.

FIG. 5 illustrates another process for managing resource requests in an implementation.

FIG. 6 illustrates another operational sequence in an implementation.

FIG. 7 illustrates a compute cluster in an implementation

FIG. 8 illustrates a computing system suitable for implementing the various operational environments, architectures, environments, processes, scenarios, sequences, and frameworks discussed below with respect to the other Figures.

### DETAILED DESCRIPTION

Various embodiments of the present technology enable dynamic resource allocation for applications running in workload orchestration platforms (e.g., Kubernetes). Historically, each workload's request values (e.g., an amount of CPU or memory reserved for pods in the workload) are specified in a workload configuration, and the orchestration platform's scheduler matches these request values to a node with sufficient capacity. These request values may be set manually by developers in the workload configuration or may be automatically calculated and implemented in the configuration in a process referred to as “right-sizing.”

Common approaches to setting request values for workloads (right-sizing) are as follows: 1) setting request values to the peak demand during startup, or 2) setting request values to the steady-state demand. Some applications (e.g., those written in Java programming language) have much higher resource demand on startup compared to steady state. When the workload's request value (e.g., for CPU and memory) is set to the higher resource demand during startup, the workload may be over-provisioned most of the time (e.g., resources are reserved for a peak demand of an application and will not be fully utilized during other parts of the application's lifecycle). Consider an application that needs 4 CPUs and 8 GB of memory during startup but only 2 CPUs and 4 GB of memory during steady state. If the resources are allocated based on the startup needs, the application will reserve the extra 2 CPUs and 4 GB of memory during steady state without actively using these resources, creating inefficiencies due to overprovisioning.

When request values are set to the steady-state demand, the application is likely to get throttled during startup due to resource congestion. As a result, the application may even fail to start (e.g., due to timeouts). For example, an application that requires 4 CPUs during startup but is only allocated 2 CPUs based on steady-state needs might fail to initialize properly, due to the node not having sufficient available capacity to accommodate the initialization. With fixed resource allocation, existing systems fail to avoid both over-provisioning during steady-state and under-provisioning during startup.

In contrast, various implementations of the technology described herein provide for dynamic resource allocation to accommodate fluctuations in an application's resource demands throughout the application's lifecycle. The disclosure describes a node management service that leverages extended resource definitions (additional resource types recognized by the orchestration platform) to allow workloads to be configured with separate request values for the high resource usage phases of a pod (such as initialization or periods of high demand for applications in the workload) and low resource usage phases (such as steady-state operations or periods of low demand for applications in the workload). Each workload in a compute cluster is defined with both request values for standard resources and request values for extended resources. These request values identify minimum resources for containerized applications (i.e., “pods”) in the workload. The standard resource request values (e.g., CPU and memory) may be set to reflect the workload's usage during low-usage phases such as steady-state operations. The extended resource definitions (e.g., CPU with headroom or Memory with headroom as described herein) may be configured to reflect the increased resource usage during high-usage phases such as initialization (e.g., a workload could have a CPU request of 4 and a CPU with headroom request of 8, as illustrated in Workload 3 in of Table 1 below). The request values are defined in metadata of a configuration file (e.g., a YAML file in Kubernetes), an example of which is illustrated below.

### Example Workload Resource Configuration

```
resources:
  requests:
      cpu: “1”
      memory: “100M”
      cpuWithHeadroom: “2”
      memoryWithHeadroom: “200M”
```

In the Example Workload Configuration, the workload requests include 1 CPU and 100 MB of memory to accommodate steady-state operations. The workload further requests 2 “CPU with headroom” and 200 MB of “Memory with headroom” to accommodate increased demand during startup. These resources define the minimum available resources for each resource type (CPU, memory, CPU with headroom, and Memory with headroom) on a compute node for deploying the workload (e.g., pods in the workload) to the compute node. Various workloads may have different request values to accommodate the resource needs of containerized applications in the workload. For example, some workloads may need additional CPU and memory during startup and may thus request additional CPU/Memory with headroom, as illustrates with respect to Workloads 1 and 2 in Table 1 below. Other workloads may not utilize additional resources during startup, and may thus have matching request values (e.g., between CPU and CPU with headroom), as illustrated in Workload 3 of Table 1 below.

TABLE 1

| | CPU | CPU w/ | Memory | Memory w/ |
|---|---|---|---|---|
| Workload | request | headroom | (MB) | headroom (MB) |
| 1 | 4 | 8 | 200 | 300 |
| 2 | 1 | 2 | 100 | 200 |
| 3 | 1 | 1 | 200 | 200 |

Once the pods in the workload are deployed to nodes in the compute cluster, the node management service monitors lifecycle events of the pods. For instance, a pod might transition from high-demand phases of its lifecycle (such as initialization or a period of high demand for the applications in the workload), to a lower-demand phase (e.g., steady-state operations after initialization or a period of lower demand for the applications in the workload).

Upon detecting that a pod has transitioned from a high-demand phase (e.g., initialization) to a lower demand phase (e.g., steady-state operations), the node management service retrieves the pod's request values for the extended resource and adjusts the node's resource capacity accordingly. In other words, once an application transitions from startup to steady-state, the system reclaims the unused “headroom” and updates the node's metadata to make that headroom available for scheduling other pods; (specifically, by increasing the node's capacity for the extended resource by the difference between the extended resource request value and the steady-state request value). The scheduler of the orchestration platform (e.g., the Kubernetes scheduler), in turn, relies on this updated metadata to make informed decisions when placing new pods in the workload. In this manner, dynamic resource allocation ensures that applications have the additional resources they need only when they need them, enhancing efficiency and avoiding both overprovisioning and under-provisioning.

Various embodiments of the present technology provide for a wide range of technical effects, advantages, and/or improvements to computing systems and components. For example, various embodiments may include one or more of the following technical effects, advantages, and/or improvements: 1) non-routine and unconventional dynamic implementation of a node management service; 2) non-routine and unconventional operations for setting request values for workloads in a cluster; 3) use of an extended resource type (e.g., CPU with headroom) which can be dynamically adjusted to allocate resources and meet changing resource needs; 4) dynamic modification of resource capacity metadata for nodes in a cluster; 5) non-routine and unconventional use of extended resources to improve the efficiency of system resource utilization during all stages of an application lifecycle; and/or 6) non-routine and unconventional use of extended resource definitions in a compute cluster.

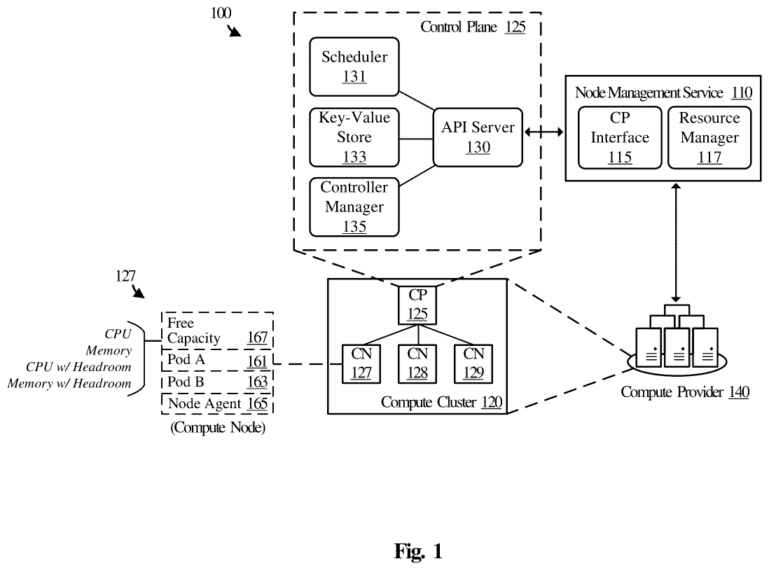

FIG. 1 illustrates compute environment 100 in an implementation. Compute environment 100 includes node management service 110, control plane 125, compute cluster 120 and compute provider 140. Node management service 110 is in communication with control plane 125 and compute provider 140. Control plane 125 operates in compute cluster 120. However, it is noted that in various implementations compute environment 100 may include different or additional components not listed here for brevity.

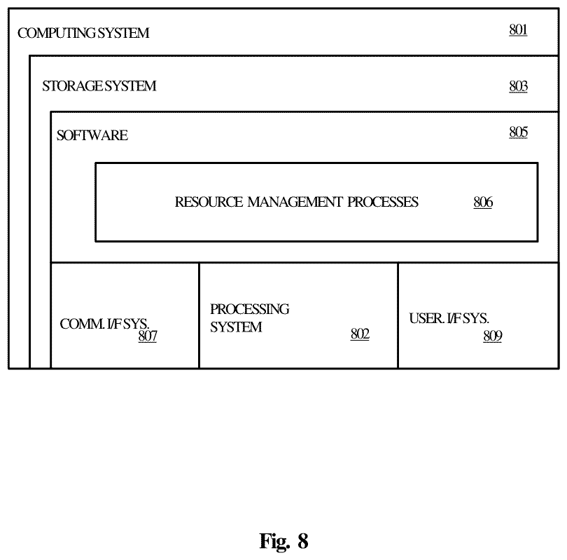

Node management service 110 is representative of a software service for managing compute nodes 127, 128, 129 in compute cluster 120. Node management service 110 may be a cloud-based service or may operate from one or more servers, which may be represented by computing system 801 of FIG. 8. Node management service 110 may be integrated into compute provider 140 (e.g., as a service offered by compute provider 140) in some implementations. In other implementations, node management service 110 may be a third-party or standalone service. Node management service 110 interfaces with compute cluster 120 via API server 130 of control plane 125. Node management service 110 includes control plane interface 115 and resource manager 117. However, it is noted that in various implementations, node management service 110 may include different or additional components not listed here for brevity.

Control plane interface 115 is representative of a service such as an API layer that interfaces with API server 130 of control plane 125. Control plane interface 115 is configured to obtain scale-up requests from API server 130, including requests to scale up new workloads (i.e., a group of one or more pods hosting containerized applications) in compute cluster 120. In some implementations, the scale-up request identifies the name of the workload, the desired number of pod replicas. This scale-up request may be triggered, for example, by a pod autoscaler of control plane 125 (e.g., a Horizontal Pod Autoscaler of Kubernetes). Control plane interface 115 receives such requests from API server 130, and subsequently relays them to node management service 110 so the appropriate resource allocations can be determined and updated in key-value store 133.

Control plane interface 115 is also configured to provide workload request values to API server 130 for updating key-value store 133. These request values may include native resource request values for a workload such as CPU and memory. The request values may also include resource request values for one or more defined extended resources that indicate resource requirements for pods during initialization or startup. The extended resources may define the CPU or memory (or both) utilization during initialization of a pod, which may be higher than its steady-state utilization of CPU. Accordingly, the request values for a given pod may include both natively defined request values (e.g., for CPU and memory) request value and extended-resource request values (e.g., CPU with headroom and Memory with headroom as described further below). The native request values (CPU and memory) identify resource utilization of pods during steady-state operations and the extended resource request values (CPU with headroom and Memory with headroom) identify resource utilization of the pods during initialization.

Extended resources, as defined for example by Kubernetes, allow cluster operators and third-party providers to introduce resource types beyond the natively defined CPU and memory resources. In Kubernetes, CPU and memory are intrinsic (native) resource types known and managed by control plane 125, representing fundamental compute and storage capabilities of a node. CPU units correspond to available cores or vCPUs, and memory corresponds to available RAM. Together, these native resources form the baseline against which scheduler 131 measures workload demands. Extended resources build upon this baseline by defining additional consumable quantities that scheduler 131 can consider when placing pods on compute nodes 127, 128, 129. The extended resources may define CPU utilization during a pod's startup or initialization period (referred to herein as “CPU with headroom”), the memory utilization during a pod's startup (referred to herein as “Memory with headroom”), or both. Additionally, while extended resources for CPU and memory are described herein, it is noted that the extended resource may alternatively or additionally include other resource types such as GPU in various implementations.

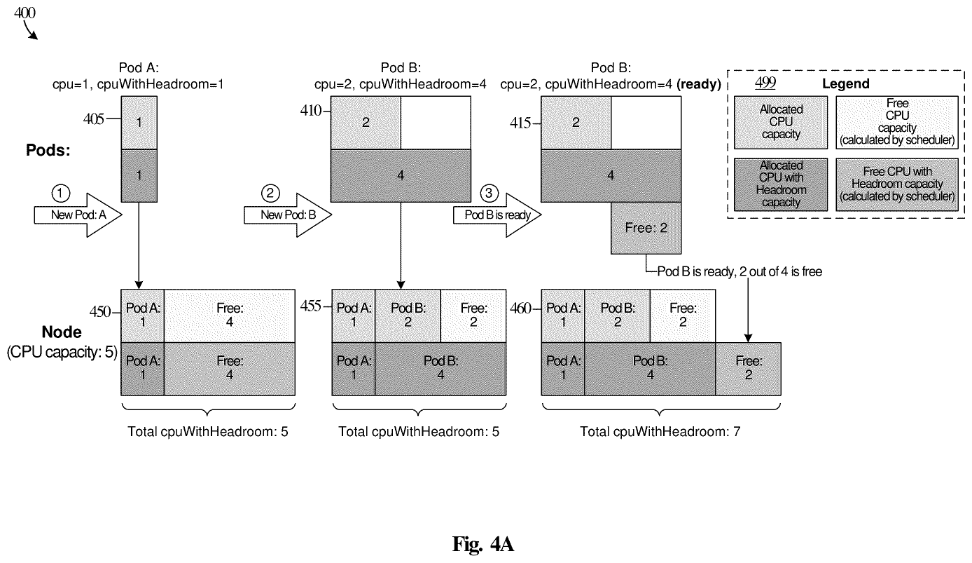

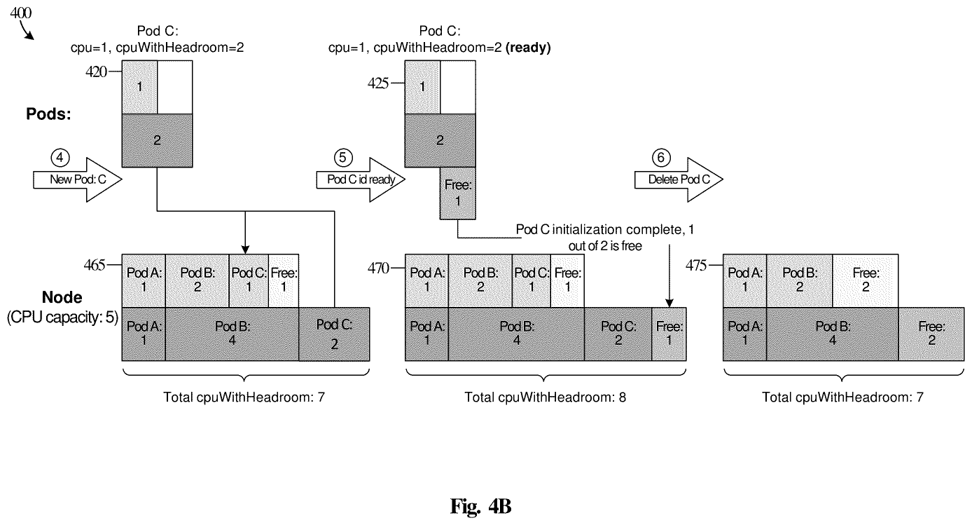

Control plane interface 115 also provides, to API server 130, requests for updates to metadata in key-value store 133 associated with compute nodes 127. The metadata of a compute node 127 in key-value store 133 contains several values regarding the capacity and state of the node. For example, it may include the total allocatable CPU capacity for both native and extended resources, the free capacity for both native and extended resources, and labels or annotations indicating the operational state of nodes (e.g., “initialization phase,” “ready for deployment” when compute node 127 is ready to accept new pods, “disk pressure” when compute node 127 has low disk capacity, and “memory pressure” where compute node has low memory). Node agent 165 identifies these various states on compute nodes 127, 128, 129 and updates key-value store with the detected states. Node management service 110 also updates to the metadata to define the nodes' capacity of the extended resource (e.g., CPU with headroom and/or Memory with headroom). These changes are determined by resource manager 117, as explained further below. The dynamic adjustment of the node metadata is also illustrated and described further below with respect to workflow 400 in FIGS. 4A and 4B.

Resource manager 117 is representative of a controller in node management service 110 that manages resources in compute cluster 120. Resource manager 117 is configured to perform right-sizing functions for pod resource requests, including setting request values for both native resources (CPU and memory) and extended resources (CPU with headroom and/or Memory with headroom) for workloads. Resource manager 117 performs right-sizing by calculating request values for a workload that strikes a balance between over-provisioning and under-provisioning. This calculation may be based on historical resource usage data of the application or applications in the pods. Resource manager 117 may right-size both the native CPU resource and the extended CPU resource (CPU with headroom and/or Memory with headroom) by analyzing historical resource usage throughout the lifecycle of pods in the workload in previous deployments. In particular, resource manager 117 may calculate the native CPU request value based on historical steady-state usage of applications, and the extended CPU request value (CPU with headroom and/or Memory with headroom) based on the observed or anticipated startup resource demands. However, in some cases an application owner or user may also manually define these request values when setting a workload configuration.

Resource manager 117 is also configured to determine that initialization of pods on compute nodes 127 is complete. This may include, for example, receiving an indication from an application running in the pod that the application is ready to handle external requests or web traffic, by monitoring a readiness probe in compute cluster 120. Such readiness probes may be executed by node agent 165 (e.g., Kubelet) on compute nodes 127, which updates a readiness status of a pod in key-value store 133 when the pod is ready to handle external traffic. Node management service 110 may in turn monitor the readiness status of pods in key-value store 133 to determine when pods have completed the initialization phase. In other implementations the determination that initialization is complete may be based on elapse of a predetermined time period (e.g., 1 minute, 5 minutes, 10 minutes, etc.) since deployment of the pod to a node. This time period may be determined based on the time applications on a given pod take to initialize and may vary depending on the initialization time of a particular pod. In other implementations, resource manager 117 may utilize various other methods to determine that the initialization is complete.

Resource manager 117 is further configured to update capacity metadata of the extended resource in compute nodes 127 (in key-value store 133 and via control plane interface 115) upon determining that initialization is complete. In particular, resource manager 117 may increase the extended resource metadata (e.g., “CPU with headroom” capacity of a compute node 127, 128, 129) by a difference between the extended resource value for the pod (e.g., the “CPU with headroom”) and the native request value for the pod (e.g., the CPU request aligning with steady-state needs). Thus, resource manager 117 synthetically increases the value of the extended resource such that the scheduler 131 may account for resource availability for handling initialization of future pods. This increase is illustrated and described with respect to workflow 400 of FIGS. 4A and 4B. Resource manager 117 may also decrease the capacity metadata when pods are scaled down from compute nodes 127, as explained further in the discussion of FIGS. 4A and 4B.

It is noted that the extended resource capacity metadata for a compute node 127 (e.g., CPU with headroom and/or Memory with headroom) does not always align with the actual CPU or memory capacity of the virtual machine or server hosting the node. When compute nodes 127, 128, 129 are first initialized, resource manager 117 sets the “CPU with headroom” capacity to match the actual CPU capacity of the node (thus matching the node's CPU capacity with its CPU with headroom capacity); and likewise, for “Memory with headroom” according to some implementations. However, as pods with disparate request values are added to a compute node 127, 128, or 129, resource manager 117 increases the CPU with headroom capacity metadata (or Memory with headroom capacity data) above the actual capacity of compute nodes 127 to signal resource availability. This is performed because, during steady state after a pod is initialized, it reserves more “CPU with headroom” and/or “Memory with headroom” than the CPU/memory actually utilized by the pod. Increasing the “CPU with headroom” and/or “Memory with headroom” capacity accounts for this discrepancy, signaling to scheduler 131 that “headroom” is available to accommodate the initialization of future pods. Accordingly, “CPU with headroom” and “Memory with headroom” are understood as an extended or synthetic resources of a node that do not necessarily reflect the actual operational compute reservations of the node. This concept is illustrated and explained further below in the discussion of workflow 400 of FIGS. 4A and 4B.

In various embodiments, resource manager 117 dynamically updates node metadata representing node resource capacity during different phases of the application life cycle for pods deployed to compute nodes 127, 128, 129. This update to the node capacity effectively “tricks” control plane 125 to allow for more efficient resource utilization. For example, if an initial phase requires more resources than a later phase, control plane 125 can assign workloads based on the higher initial resource needs and then increase the node's available capacity as resource usage decreases in the later phase.

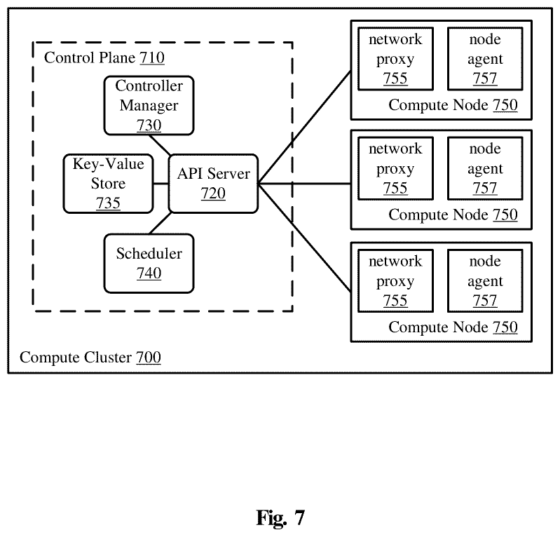

Control plane 125 represents an orchestration platform that manages and coordinates the resources within compute cluster 120. Control plane 125 may be represented by control plane 710 of FIG. 7. Control plane 125 may operate in one or more nodes of compute cluster 120. Control plane 125 may be a Kubernetes control plane in some implementations. However, it is noted that the concepts described herein are not limited to Kubernetes and may be applied to other orchestration platforms. Control plane 125 includes scheduler 131, key-value store 133, and controller manager 135. However, it is noted that in various implementations, control plane 125 may include different or additional components not listed here for brevity.

Scheduler 131 is configured to schedule pending pods to compute nodes 127. Scheduler 131 reads data from key-value store 133 to identify created pods that are ready for scheduling. Scheduler 131 identifies compute nodes 127 that have sufficient available compute capacity to accommodate the request values of the pending pods, including native resource request values (CPU and memory) and extended resource request values such as CPU with headroom and Memory with headroom. To make this determination, scheduler 131 determines the “free capacity” for each resource type on compute nodes 127, 128, 129. Specifically, scheduler 131 takes the total capacity for each resource type and subtracts the amount being consumed by pods deployed to the compute nodes (determined based on the request values). The relevant data for performing this calculation may be retrieved from key-value store 133. Scheduler 131 binds each pending pod with a compute node 127, 128, or 129 having sufficient capacity for each requested resource. The increase of the “CPU with headroom” capacity metadata for compute nodes 127, 128, 129 provides scheduler 131 with an indication of which compute nodes 127, 128, 129 have sufficient available capacity to accommodate the initialization phase of pending pods. Scheduler 131 may be represented by scheduler 740 of FIG. 7.

Key-value store 133 represents a data store that holds parameters used to orchestrate and manage the state of compute cluster 120 including the lifecycle of pods in the cluster. Key-value store 133 contains request values for the pods (for both native CPU and memory resources and extended resources such as CPU with headroom and Memory with headroom) as well as the readiness status of pods as indicated by pod readiness probes in compute nodes 127. Key-value store 133 also includes resource capacity metadata for compute nodes 127, including each node's capacity for native resources (CPU and memory) and extended resources such as CPU with headroom. Node management service 110 updates the metadata for the CPU with headroom capacity for nodes after pod initialization, as described herein. Key-value store 133 may be represented by key-value store 735 of FIG. 7.

Controller manager 135 represents a suite of controllers that continuously observe the state of compute cluster 120 through key-value store 133 and adjust cluster operations to match desired configurations. For example, if a scale-up request is issued (e.g., in response to increased workload), controller manager 135 initiates the creation of new pods by updating the cluster state through key-value store 133. As the node management service 110 updates the “CPU with headroom” capacity after pod initialization, controller manager 135 can trigger scheduling events that capitalize on the newly freed initialization-phase capacity. By coordinating with scheduler 131 and leveraging updated node capacity metadata (including the extended resources described herein), controller manager 135 accommodates both steady-state and startup CPU utilization. Controller manager 135 may be represented by controller manager 730 of FIG. 7.

Compute cluster 120 is representative of a cluster of compute nodes 127, 128, 129 orchestrated by control plane 125. Compute cluster 120 may be, for example, a Kubernetes cluster, however it is noted that the described technology is applicable to clusters in other orchestration platforms. Control plane 125, described above, may be a service operating in one or more compute nodes 127, 128, 129 of compute cluster 120. While three compute nodes 127, 128, 129 are shown in FIG. 1 for simplicity, compute cluster 120 may include any number of compute nodes. Compute cluster 120 may be represented by compute cluster 700 of FIG. 7.

Compute nodes 127, 128, 129 may be implemented in virtual machines or physical servers (e.g., computing system 801 shown in FIG. 8), depending on the deployment. These resources may be provisioned from compute provider 140, which operates the physical infrastructure (including data centers) that provides the computing resources for hosting compute nodes 127, 128, 129.

FIG. 1 also illustrates an expanded view of compute node 127, which may be representative of each compute node 127, 128, 129 of compute cluster 120. Compute node 127 may be a virtual machine for running processes, including pods 161, 163, and node agent 165. While two pods are illustrated in FIG. 1 for brevity, compute node 127 may run any number of pods. Free capacity 167 represents currently unutilized resources of compute node 127, allowing scheduler 131 to schedule additional pods to compute node 127. Each time a pod (e.g., pods 161, 163) is deployed to compute node 127, the free capacity 167 for each resource type decreases by the amount specified in the request value of the pod 161, 163. However, increasing the overall capacity of the extended resource (as described herein) on compute node 127 synthetically makes available more free capacity (“headroom”) for scheduling new pods to compute node 127. Increasing the overall capacity of compute node for an extended resource (CPU with headroom or Memory with headroom) provides that organizations can reserve more resources during initialization without “using up” the full amount of this resource for the entire lifecycle of the pod 161, 163.

Pods 161, 163, as referenced herein, are deployable units of computing within a container orchestration platform such as Kubernetes. Each pod encapsulates one or more containerized applications. A workload may consist of multiple pods (e.g., pod replicas in a ReplicaSet of Kubernetes) that run concurrently in compute cluster 120 to meet usage demands. Resource manager 117 collects information about pods running in compute cluster 120 to estimate a level of disruptions of the workload, including violations of graceful termination and minimum capacity requirements. Resource manager 117 utilizes this data to make informed decisions about whether resource allocations need to be updated, as described in greater detail herein. Pods are scheduled to compute nodes 127, 128, 129 by control plane 125. Each compute node 127, 128, 129 in compute cluster 120 may host one or more pods from various workloads.

Node agent 165, (e.g., Kubernetes Kubelet), is configured to report on the status of processes running on compute node 127 (e.g., pods 161, 163). Node agent 165 identifies the status of pods 161, 163 (e.g., whether it is starting up, running, deleted, etc.) and updates the status in key-value store 133. Resource manager 117 in turn utilizes this information to determine when startup is complete to adjust the extended resource capacity of compute nodes 127, 128, 129 (e.g., CPU with headroom and Memory with headroom).

In various implementations, compute nodes 127, 128, 129 may vary in resource configurations and availability. For example, some compute nodes offered by compute provider 140 may have a larger memory footprint (e.g., “high-memory” configurations), whereas others may offer more CPU (“high-CPU” configurations). Because compute cluster 120 may contain an assortment of these node types, resource manager 117 is responsible for dynamically matching workloads to the most suitable node based on current capacity, resource requirements, and node characteristics. Examples of resource availability for various compute nodes are illustrated in Table 2 below. It is noted that Table 2 provides a selection of types of compute nodes 127, 128, 129 for illustrative purposes; compute provider 140 may offer a wide range of instance types for compute nodes with different resource configurations.

TABLE 2

| Compute Node Type | CPUs | Memory (GB) |
|---|---|---|
| General Purpose Node | 4 | 8 |
| High CPU Node | 16 | 8 |
| High Memory Node | 4 | 16 |

Compute provider 140 represents a source of compute resources, including preemptible and non-preemptible virtual machines (VMs) that host compute nodes 127, 128, 129. These VMs may be operated from servers distributed across one or more geographic locations and are made available to customers, such as workload application owners, for use in compute clusters like compute cluster 120. In some implementations, node management service 110 may be provided by compute provider 140, in which case it is integrated into compute provider 140. In other implementations, node management service 110 may be offered by a third party, independent of compute provider 140. Examples of compute providers include Amazon Web Services, Google Cloud, IBM Cloud, and others.

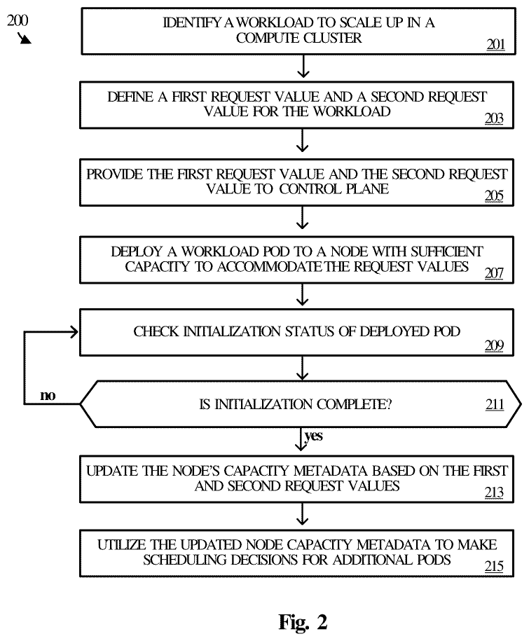

FIG. 2 illustrates a resource management process performed by node management service 110, represented by process 200. Process 200 is employed by a computing device to provide resource management, an example of which is provided by computing system 801 of FIG. 8. Process 200 may be implemented in program instructions (software and/or firmware) by one or more processors of the computing device. The program instructions direct the computing device to operate as follows, referring parenthetically to the steps in FIG. 2.

Node management service 110 identifies a workload to scale up in compute cluster 120 (step 201). The workload may consist of one or more pods, such as pods 161, 163, to be deployed to compute cluster 120. Identifying the workload may include receiving an instruction to scale-up the workload from control plane 125 (e.g., to meet increased usage demands), in some implementations. This instruction can be triggered by control plane 125 based on metrics such as CPU utilization, memory usage, or incoming request throughput. For example, if existing pods in compute cluster 120 are experiencing high usage levels (e.g., sustained CPU load above a defined threshold), control plane 125 may determine to scale up additional replicas to meet usage demands. In other implementations, the identification of the workload may occur when a user submits a request to deploy a new application or service into compute cluster 120.

Node management service 110 defines the first request value and the second request value for the workload (step 203). The first request value is associated with a resource usage of a pod in the workload during a low-resource usage phase (e.g., steady-state operations or periods of low demand for an application hosted on the pod), and the second request value is associated with the resource usage of the pod during a high-usage phase (e.g., initialization of the pod or periods of high demand for the application). The first request value may be associated with the native resource definition utilized by control plane 125 (e.g., for CPU or memory), and the second request value may be associated with an extended resource definition (e.g., “CPU with headroom” or “Memory with headroom” as described herein). Accordingly, the native CPU resource is used to define the pod's resource utilization during low-demand periods such as steady state, while the extended resource is used for the pod's utilization of CPU resources during high demand periods such as initialization or startup. The request values may be defined in workload configuration metadata or pod configuration metadata.

To define the request values, node management service 110 may perform automatic “right-sizing” in some implementations. This process may include analyzing historical resource usage of the pod in previous deployments. For instance, the service can employ machine learning algorithms to predict optimal resource requirements by examining past CPU and memory consumption patterns during both high demand (e.g., startup) and low demand (e.g., steady-state) phases. In other scenarios, defining the request values may include identifying manually configured request values (e.g., a developer may manually set the request values for CPU, memory, CPU with Headroom, and/or Memory with headroom in the workload configuration metadata).

It is noted that the concepts described with respect to process 200 are not limited to startup and initialization; in other implementations, the first and second request values may be associated with various other phases in an application's lifecycle. For example, the first request value may be associated with “Phase One” operations (e.g., periods of increased application usage or initialization periods) and “Phase Two” operations, which may include periods of lighter demand (e.g., periods of decreased application usage or steady-state operations).

Node management service 110 provides the first request value and the second request value to control plane 125 (step 205). Specifically, node management service 110 updates key-value store 133 with the first request value and the second request value. Scheduler 131 then utilizes these request values to schedule the pod to a compute node 127 based at least in part on the first request value and the second request value of the pod, as well as the node capacity metadata for compute node 127, 128, or 129 retrieved from key-value store 133.

Control plane 125 deploys the pod to a compute node 127 in compute cluster 120 having sufficient capacity to accommodate the request values (step 207). Scheduler 131 checks metadata for pending pods and compute nodes 127 in key-value store 133 to identify those compute nodes with sufficient free capacity (e.g., free capacity 167 of FIG. 1) for each resource type (e.g., CPU, Memory, CPU with headroom, and Memory with headroom) of the pending pod. Once a compute node 127 is selected, control plane 125 instructs node agent 165 to instantiate and run pods' containerized application(s) on compute node 127.

Node management service 110 checks the status for the pod (step 209). In some implementations, node management service 110 can leverage pod lifecycle events (e.g., indications from readiness probes) to check the current state of the application. Readiness probes are mechanisms configured on a pod that check whether an application is ready to handle external requests. When a readiness probe succeeds, it indicates that the application within the pod has completed its startup tasks and is now ready to serve traffic, effectively signaling the end of the initialization phase. In other implementations, checking the status may include determining whether a predetermined time-period (e.g., 1 minute, 5 minutes, 10 minutes, etc.) has elapsed since the start of deployment of the pod to the node.

Node management service 110 determines if initialization of the pod on compute node 127 is complete (step 211). If the pod status (as identified in step 209) indicates that initialization is complete (e.g., the readiness probe indicates that the application is ready to handle requests, or the predetermined time-period is complete), process 200 proceeds to step 213. If initialization is not complete (e.g., the readiness probe indicates that the application is still initializing, or the predetermined time-period has elapsed), process 200 returns to step 209 for continued monitoring.

In other implementations, step 211 may include detecting a transition of the pod from any high-usage phase (such as periods of high demand of the application) to the low-usage phase (such as periods of low demand for the application). To accomplish this, node management service 110 may continuously collect and analyze metrics (e.g., CPU utilization, memory consumption, or network throughput) from pods in compute cluster 120. When these metrics fall below a predefined threshold (such as a certain percentage of CPU usage over a rolling time window) node management service 110 identifies that the pod has shifted into the low-usage phase.

Node management service 110 updates the capacity metadata for compute node 127, 128, 129 in control plane 125 (step 213). Specifically, node management service 110 increases the extended resource (e.g., CPU with headroom and/or Memory with headroom) capacity metadata in key-value store 133. To calculate the new capacity for the extended resource, node management service 110 retrieves the first and second request values for the deployed pod (e.g., from the pod's workload configuration metadata). It then takes a difference between the pod's second request value (for the extended resource such as CPU with headroom or Memory with headroom) and the pod's first request value (for the native CPU or memory resource). It then adds this difference to the current capacity of compute node 127 for the extended resource (CPU with headroom or Memory with headroom).

For example, consider a pod that has a CPU request value of 3 (reflecting steady-state usage) and a “CPU with headroom” request value of 4 (reflecting increased initialization usage). The pod has been deployed to a compute node 127 that has a total capacity of 8 for the native CPU resource and a total capacity of 8 for the extended resource “CPU with headroom.” After determining that the initialization period for the pod is complete (at step 211), node management service 110 calculates the updated capacity for compute node 127 by taking between the pod's “CPU with headroom” request value and CPU request value as follows: 4−3=1. Node management service increases the node's capacity for “CPU with headroom” by 1 (the difference) to arrive at 9. Thus, after initialization, the total capacity of compute node 127 for “CPU with headroom” is updated to 9 (8+1); while the total capacity for “CPU” (the natively defined resource) remains static at 8.

Control plane 125 utilizes the updated node capacity metadata to make scheduling decisions for additional pending pods (step 215). Scheduler 131 retrieves, from key-value store 133, the request values for the additional pending pods and the free capacity of compute nodes 127, 128, 129 for both native and extended resources (e.g., CPU with headroom and Memory with headroom). Scheduler 131 schedules pending pods that have sufficient free capacity for each resource type (e.g., CPU, Memory, CPU with Headroom, and/or Memory with headroom). Updating the capacity value for the extended resource definition (e.g., CPU with headroom and/or Memory with headroom) thus frees up room for the scheduling of these additional pods.

This adjustment process enhances resource utilization and scheduling efficiency by reclaiming unused headroom once a pod completes its initialization phase. By recalculating and increasing the extended resource capacity for compute nodes 127, 128, 129 based on the difference between initialization and steady-state demands, the system ensures that available resources reflect real-time availability without overprovisioning.

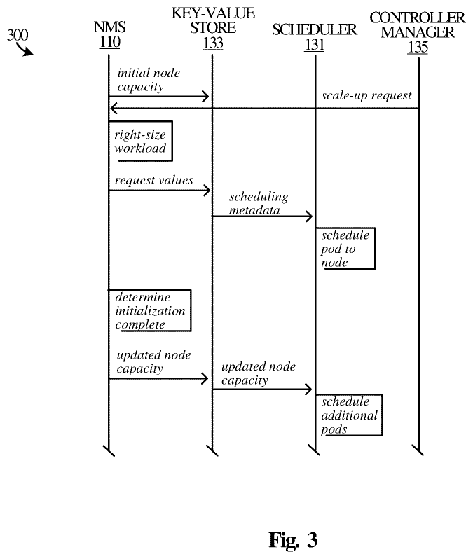

FIG. 3 illustrates an operation sequence of an application of process 200 in the context of compute environment 100 in an implementation, represented by sequence 300. Sequence 300 includes node management service 110, key-value store 133, scheduler 131, and controller manager 135. Various operations in sequence 300 may be performed via API server 130 of FIG. 1.

In sequence 300, node management service 110 sets, in key-value store 133, initial node capacity metadata for nodes in compute cluster 120 (which may include initializing the “CPU with headroom” capacity to match the native CPU resource capacity and/or initializing the “Memory with headroom” capacity to match the native memory resource capacity). Node management service 110 obtains a scale-up request from controller manager 135. This scale-up request may identify new pods to scale-up in compute cluster 120 (for example based on increased demand for an application or a new deployment). Node management service 110 right-sizes the workload, including setting both native resource request values (CPU and memory) and extended resource request values (e.g., CPU with headroom and Memory with headroom). However, it is noted that in some implementations, the request values may be user-defined or a combination of user-defined and system defined (e.g., a user may define the “CPU with headroom” request while node management service 110 defines the CPU request, or vice versa).

Node management service 110 updates key-value store 133 with the request values for the pods. Scheduler 131 obtains scheduling metadata from key-value store 133 (including the request values and the CPU capacity values) and schedules pods to compute nodes 127, 128, 129 based at least in part on the nodes having sufficient free capacity for each resource (including native and extended) to accommodate the request values of the pod. Node management service 110 determines that initialization of the pod on compute nodes 127 is complete after deployment (thus identifying that the pod is no longer actively utilizing the full “CPU with headroom resource” request amount). Node management service 110 updates the node capacity metadata in key-value store 133. Specifically, node management service 110 increases the “CPU with headroom” resource capacity by a difference between the native CPU request of the pod with the CPU with headroom request. Scheduler 131 retrieves this updated capacity metadata from key-value store 133 and utilizes this metadata to make scheduling determinations, as discussed above with respect to step 215 of process 200.

FIGS. 4A and 4B illustrate workflow 400, which illustrates a sequence of deployments and removals of pods leveraging the extended resource defined herein. The operations illustrated in workflow 400 may be performed by node management service 110 operating in conjunction with control plane 125. Steps in workflow 400 are represented by circled numbers in FIG. 4. The top bar of elements in FIGS. 4A and 4B is representative of a native CPU resource, while the bottom bar is illustrative of the “CPU with headroom” resource, as illustrated in the legend of element 499. FIGS. 4A and 4B illustrate the native CPU resource as “cpu” and the extended CPU resource as “cpuWithHeadroom,” which may be the naming conventions used in control plane 125 and compute cluster 120; however, it is noted that other naming conventions may be utilized in various implementations. Further, while FIGS. 4A and 4B are illustrated with respect to CPU resources, the same concepts described are applicable to other resource types (e.g., the native memory resource and the extended “Memory with headroom” resource described herein).

Step 1 illustrates deployment of Pod A (represented by element 405) to a node (represented by element 450) which may be one of compute nodes 127 in compute cluster 120 of FIG. 1. Pod A has a CPU request of 1 and a “CPU with headroom” request of 1. (Accordingly, Pod A does not request additional resources for its initialization phase). These request values may be determined by node management service 110 right-sizing operations, or may be user-defined, as explained above. Element 450 illustrates the resource state of the node upon deployment of Pod A. The node has a total CPU capacity of 5 (which may represent 5 CPU cores or vCPUs). Further, the node begins with a total “CPU with headroom” capacity of 5 (noting that node management service 110 may initialize the node with a “CPU with headroom” capacity equal to the native CPU capacity). Element 450 illustrates that deployment of Pod A to the node does not trigger a change of the CPU with headroom capacity of the node, since the pod has the same request value (1) for both the “CPU with headroom” resource and the CPU resource. Upon deployment of Pod A, the free capacity for both CPU and CPU with headroom in the node is 4.

Step 2 illustrates deployment of pod B (represented by element 410) to the node (represented by element 455). Pod B has a CPU request of 2 and a “CPU with headroom” request of 4. In scheduling Pod B, scheduler 131 identifies a node that has free CPU capacity of 2 and free “CPU with headroom” capacity of 4. Element 455 illustrates that deployment of Pod B to the node consumed the remaining CPU with headroom capacity (making further pods unschedulable to the node during initialization of Pod B and mitigating the chances of congestion), while leaving a free CPU capacity of 2. It is noted that in the described technology, each pod deployed to compute cluster 120 may be defined with a “CPU with headroom” request that is not smaller than its CPU request.

Step 3 illustrates the modification of the node's CPU with headroom capacity (represented by element 460) after Pod B has completed initialization (as illustrated in element 415). Specifically, Pod B may only consume 2 cpu during steady-state, while still reserving 4 “CPU with headroom” with its request value. Accordingly, there are 2 “free” CPU with headroom resources available in this scenario. After initialization of Pod B, node management service 110 updates the CPU with headroom capacity of the node by 2 (the difference between pod B's CPU request and CPU with headroom request) to convey to scheduler 131 that the node has available “headroom” for accommodating the initialization of future pods (as described above in relation to steps 205 and 207 of process 200). In other words, the total CPU with headroom capacity is increased such that the free CPU with headroom capacity (i.e., the available CPU with headroom) matches the free CPU capacity after initialization of a pod is complete (noting that during initialization, the free capacity of these resources does not match, thus avoiding overscheduling on the node during initialization of pods). Element 460 illustrates that the node has 2 CPU that are not being actively utilized by currently deployed pods.

Continuing in FIG. 4B, step 4 of workflow 400 illustrates deployment of Pod C (represented by element 420) to the node (represented by element 465). In this case, Pod C has a CPU request of 1 and a CPU with headroom request of 2. The node can accommodate Pod C, as illustrated in element 465 (since in its previous state at element 460 the free capacity for both resources was 2). It is noted that absent the increase in CPU with headroom capacity at step 3, the node would not have sufficient CPU with headroom to accommodate pod C, making Pod C unschedulable to the node. Thus, adjusting the CPU with headroom as described herein allows space to be freed up after initialization is complete.

Step 5 illustrates the modification of the node's CPU with headroom capacity (represented by element 470) after pod C has completed initialization (as illustrated in element 425). Similar to the discussion of step 3 above, CPU with headroom capacity is increased by the difference between Pod C's CPU request and its CPU with headroom request (in this case an increase of 1 to arrive at 8 total). Thus, after initialization of Pod C, the node has 1 free CPU and 1 free CPU with headroom.

Step 6 illustrates deletion of Pod C from the node (as illustrated in element 465). Pods may be removed due to scaling down or reduced application demand. Upon removal of Pod C, node management service 110 decreases the node's total CPU with headroom capacity by the difference between the deleted pod's CPU request and “CPU with headroom” request (in this case, 1). This reduction is performed because after deletion, Pod C no longer consumes disparate amounts of CPU and CPU with headroom on the node. Thus, the total CPU with headroom capacity is reduced from 8 to 7 after deletion. Element 475 also illustrates that resources are freed up on the node after deletion, resulting in 2 free CPU and 2 free CPU with headroom.

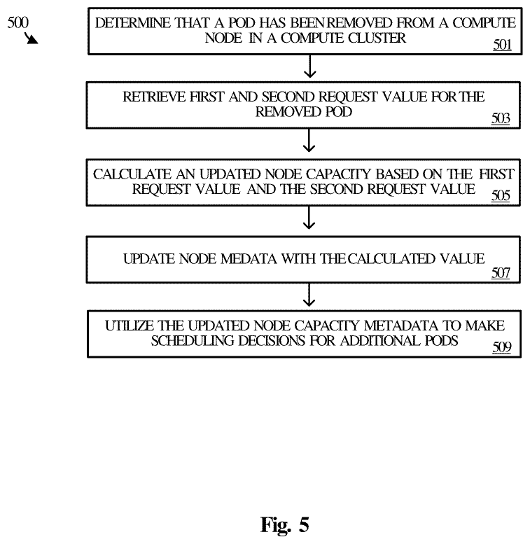

FIG. 5 illustrates a resource management process performed by node management service 110, represented by process 500. Process 500 is employed by a computing device to provide resource management, an example of which is provided by computing system 801 of FIG. 8. Process 500 may be implemented in program instructions (software and/or firmware) by one or more processors of the computing device. The program instructions direct the computing device to operate as follows, referring parenthetically to the steps in FIG. 5.

Node management service 110 determines that a pod has been removed from compute node 127 (step 501). Node management service 110 may obtain this notification, for example, from controller manager 135. It is noted that processes 200 and 500 may be integrated into one overall process in some implementations. For example, the deleted pod of step 501 may be the same pod that was previously deployed to compute node 127 as described above in process 200. Processes 200, 500 each may also operate as independent processes in various implementations.

Node management service 110 retrieves the first request value and the second request value for the pod (step 503). These values may be retrieved from key-value store 133 in some implementations. In other implementations, node management service 110 may maintain the request values in metadata internal to node management service 110.

Node management service 110 calculates, in response to determining that the pod has been removed, an updated capacity value for the compute node 127 (step 505). Specifically, node management service 110 determines an updated value for the extended resource (e.g., CPU with headroom and/or Memory with headroom) capacity in compute node 127. To calculate the updated value, node management service 110 takes a difference for the deleted pod's first request value (e.g., the pod's request value for a native CPU or Memory resource) and second request value (e.g., the request value for the CPU with headroom resource or the Memory with Headroom resource) and subtracts this difference from the current capacity for the extended resource in compute node 127. This calculation is illustrated in step 6 of FIG. 4B, where “Pod C” is deleted.

Node management service 110 updates the capacity metadata for compute node 127 in control plane 125 with the calculated value (step 507). Specifically, node management service 110 updates, in key-value store 133, the node's capacity for the extended resource (CPU with headroom and/or Memory with headroom) with the value calculated in step 503.

Control plane 125 utilizes the updated node capacity metadata to make scheduling decisions for additional pending pods (step 509). Scheduler 131 retrieves, from key-value store 133, the request values for the additional pending pods and the free capacity of compute nodes 127, 128, 129 for both native and extended resources (e.g., CPU with headroom and Memory with headroom). Scheduler 131 schedules pending pods that have sufficient free capacity for each resource type (e.g., CPU, Memory, CPU with Headroom, and/or Memory with headroom). Updating the capacity value for the extended resource definition (e.g., CPU with headroom and/or Memory with headroom) thus frees up room for the scheduling of these additional pods.

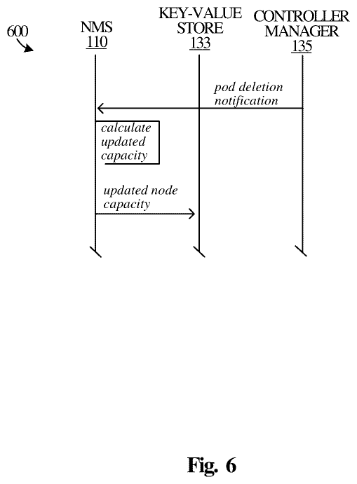

FIG. 6 illustrates an operation sequence of an application of process 500 in the context of compute environment 100 in an implementation, represented by sequence 600. Sequence 600 includes node management service 110, key-value store 133, and controller manager 135. Various operations in sequence 300 may be performed via API server 130 of FIG. 1.

To begin, controller manager 135 provides, to node management service 110, a notification that a pod has been deleted from compute node 127, as discussed above with respect to step 501 of process 500. Pod deletion may occur, for example, due to scale-down in response to reduced demand, resource optimization, or failure of the pod or its underlying infrastructure. Node management service 110 calculates an updated capacity value for the extended resource (e.g., CPU with headroom) of the compute node 127 from which the pod was deleted, as discussed above in relation to step 503 of process 500. Node management service 110 updates, in key-value store 133, the capacity metadata for the compute node 127 with the calculated capacity value for the extended resource. This update may decrease the capacity by a difference between a native request value for the deleted pod (e.g., CPU) and the request value for the extended resource (e.g., CPU with headroom or Memory with headroom). This decrease is representative of the fact that the deleted pod is no longer consuming extra “headroom” upon deletion, and the extended resource is updated accordingly.

FIG. 7 illustrates compute cluster 700 in an implementation. Compute cluster 700 includes control plane 710 and compute nodes 750. Compute cluster 700 may be a Kubernetes cluster; however, it is also representative of various other orchestration platforms.

Control plane 710 is representative of a software service that manages resources in compute cluster 700, and may, for example, be a Kubernetes control plane. Control plane 710 can operate from one or more nodes or virtual machines within compute cluster 700. Control plane 710 includes API server 720, controller manager 730, key-value store 735, and scheduler 740.

API server 720 is a central interface in control plane 710 for processing and validating requests. API server 720 is in communication with compute nodes 750, controller manager 730, key-value store 735, scheduler 740, as well as external clients such as a node management service as described herein. API server 720 processes requests (such as requests to create, update, or delete resources), validates them, and updates the state of compute cluster 700 in key-value store 735. API server 720 may also handle authentication and authorization of client requests, ensuring that only permitted users and services can access or modify cluster resources.

Controller manager 730 is representative of a service that manages controllers to maintain the state of compute cluster 700 by continuously monitoring the current state and reconciling it with the desired state as defined in key-value store 735. Controller manager 730 orchestrates tasks to achieve the desired state, such as coordinating the creation or deletion of pods to match the specified number of pod replicas, monitoring the health of compute nodes 750, and initiating replacement or recovery actions for failed nodes.

Key-value store 735, which may be Kubernetes etcd in some implementations, maintains the cluster's configuration data and state information.

Scheduler 740 assigns workloads such as pods to appropriate compute nodes 750. It makes scheduling decisions based on resource availability, constraints, and policies.

Compute nodes 750 are representative of virtual machines or physical servers on which workloads run. While three compute nodes 750 are shown in FIG. 7 for clarity, it is noted that compute cluster 700 may include any number of compute nodes. Compute node 750 includes network proxy 755 and node agent 757.

Network proxy 755 (e.g., Kube-proxy) is representative of a service running on compute node 750 that maintains network rules on compute node 750 to facilitate communication between services within the cluster. It manages network routing for service discovery and load balancing, providing that requests to a particular service are directed to one of the corresponding backend pods.

Node agent 757 (e.g., Kubelet) is representative of a service running on compute node 750 that manages the state of pods on compute node 750. Node agent 757 communicates with API server 720 to receive instructions about which pods to run. Node agent 757 performs tasks such as starting, stopping, and managing containerized workloads. Additionally, node agent 757 monitors running pods containers, collects resource usage metrics, and reports on the state of compute node 750 to control plane 710.

FIG. 8 illustrates computing system 801, which is representative of any system or collection of systems in which the various applications, processes, services, and scenarios disclosed herein may be implemented. Examples of computing system 801 include, but are not limited to server computers, web servers, cloud computing platforms, and data center equipment, as well as any other type of physical or virtual server machine, container, and any variation or combination thereof. (In some examples, computing system 801 may also be representative of desktop and laptop computers, tablet computers, and the like.)

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes and implements resource management processes 806, which is representative of the processes discussed with respect to the preceding Figures, such as process 200. When executed by processing system 802, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may include a microprocessor and other circuitry that retrieves and executes software 805 from storage system 803. Processing system multiple processing devices or sub-systems that cooperate in executing program instructions. Examples of processing system 802 include general purpose central processing units, microcontroller units, graphical processing units, application specific processors, integrated circuits, application specific integrated circuits, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 803 may be implemented as a single storage device but may also be implemented across multiple storage devices or sub-systems co-located or distributed relative to each other. Storage system 803 may comprise additional elements, such as a controller capable of communicating with processing system 802 or possibly other systems.

Software 805 (including resource management processes 806) may be implemented in program instructions and among other functions may, when executed by processing system 802, direct processing system 802 to operate as described with respect to the various operational scenarios, sequences, and processes illustrated herein. For example, software 805 may include program instructions for implementing resource management processes and procedures as described herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” “in an implementation,” “in some implementations,” and the like generally mean the particular feature, structure, or characteristic following the phrase is included in at least one implementation of the present technology, and may be included in more than one implementation. In addition, such phrases do not necessarily refer to the same embodiments or different embodiments.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A computer-implemented method for operating a node management service comprising:
defining a first request value and a second request value for a pod prior to deployment of the pod to a node in a compute cluster, wherein the first request value is associated with a resource usage of the pod during steady-state operations and the second request value is associated with the resource usage of the pod during initialization;
providing the first request value and the second request value to a control plane of the compute cluster, the control plane being configured to schedule deployment of the pod on the node based at least in part on the first request value and the second request value;
determining that initialization of the pod on the node is complete; and
in response to determining that initialization of the pod on the node is complete, updating a capacity value in metadata of the node thereby allowing the control plane to efficiently schedule additional pods to the node after the initialization.

2. The computer-implemented method of claim 1, wherein the updating the capacity value comprises increasing the capacity value by a difference between the first request value and the second request value.

3. The computer-implemented method of claim 1, further comprising:
determining that the pod has been removed from the node; and
in response to determining that the pod has been removed from the node, decreasing the capacity value in the metadata of the node.

4. The computer-implemented method of claim 3, wherein the decreasing the capacity value comprises decreasing the capacity value by a difference between the first request value and the second request value.

5. The computer-implemented method of claim 1, wherein the updated capacity value is associated with an extended resource definition that accommodates increased resource utilization of the pod during initialization.

6. The computer-implemented method of claim 1, wherein the first request value indicates a first CPU request value to accommodate steady-state operation of the pod, and the second request value indicates a second CPU request value to accommodate initialization of the pod.

7. The computer-implemented method of claim 1, wherein the determining that the initialization is complete comprises receiving an indication from an application running in the pod that the application is ready to handle external requests.

8. The computer-implemented method of claim 1, wherein the determining that the initialization is complete comprises determining that a predetermined time period has elapsed since a start of deployment of the pod to the node.

9. A system comprising:
one or more processors; and
one or more memories operably coupled to the one or more processors and having stored thereon software instructions that, upon execution by the one or more processors, cause the one or more processors to:
define, for a pod to be scaled up in a compute cluster, a first resource request value for a high-usage phase of the pod and a second resource request value for a low-usage phase of the pod;
provide, to a control plane of the compute cluster, the first resource request value and the second resource request value, the control plane being configured to schedule deployment of the pod on a node in the compute cluster based at least in part on the first resource request value and the second resource request value;
determine that the pod has transitioned from the high-usage phase to the low-usage phase; and
in response to determining that the pod has transitioned, update a capacity value in metadata of the node.

10. The system of claim 9, wherein the updating the capacity value comprises increasing the capacity value by a difference between the first resource request value and the second resource request value.

11. The system of claim 9, wherein the software instructions comprise further instructions that, upon execution by the one or more processors, cause the one or more processors to:
determine that the pod has been removed from the node; and
in response to determining that the pod has been removed from the node, decrease the capacity value in the metadata of the node.

12. The system of claim 11, wherein the decreasing the capacity value comprises decreasing the capacity value by a difference between the first resource request value and the second resource request value.

13. The system of claim 9, wherein the updated capacity value is associated with an extended resource definition that accommodates variations in resource utilization of pods in the compute cluster.

14. The system of claim 9, wherein the high-usage phase comprises a period of high demand for an application hosted by the pod and the low-usage phase comprises a period of low demand for the application.

15. The system of claim 9, wherein the high-usage phase comprises an initialization phase of the pod, and the low-usage phase comprises a steady-state phase of the pod.

16. The system of claim 15, wherein the determination that the pod has transitioned is based on a determination that the initialization phase of the pod is complete.

17. A computer-readable storage media device having program instructions stored thereon that, upon execution by one or more processors, cause the one or more processors to:
provide, to a control plane of a compute cluster, a first request value and a second request value of a pod, the control plane being configured to schedule deployment of the pod on a node in a compute cluster based at least in part on the first request value and the second request value;
determine that initialization of the pod on the node is complete; and
in response to determining that the pod has completed initialization, increase a capacity value in metadata of the node by a difference between the first request value and the second request value.

18. The computer-readable storage media device of claim 17, wherein the determining that the initialization is complete comprises receiving an indication from an application running in the pod that the application is ready to handle external requests.

19. The computer-readable storage media device of claim 17, wherein the program instructions comprise further program instructions that, upon execution by the one or more processors, cause the one or more processors to:
determine that the pod has been removed from the node; and
in response to determining that the pod has been removed from the node, decrease the capacity value in the metadata of the node.

20. The computer-readable storage media device of claim 19, wherein the decreasing the capacity value comprises decreasing the capacity value by the difference between the first request value and the second request value.
